(19) United States
(12) Patent Application Publication
(10) Pub. No.: US 2022/0129751 A1
(43) Pub. Date: Apr. 28, 2022

(54) SCALABLE AND DISTRIBUTED MACHINE LEARNING FRAMEWORK WITH UNIFIED ENCODER (SULU)

(71) Applicant: California Institute of Technology, Pasadena, CA (US)

(72) Inventors: Shreyansh Daftry, Pasadena, CA (US); Annie K. Didier, Pasadena, CA (US); Deegan J. Atha, Pasadena, CA (US); Masahiro Ono, Pasadena, CA (US); Chris A. Mattmann, Pasadena, CA (US); Zhanlin Chen, Pasadena, CA (US)

(73) Assignee: California Institute of Technology, Pasadena, CA (US)

(21) Appl. No.: 17/509,926

(22) Filed: Oct. 25, 2021

Related U.S. Application Data
(60) Provisional application No. 63/105,165, filed on Oct. 23, 2020.

(51) Int. Cl. G06N 3/08; G06N 3/04

(52) U.S. Cl. CPC G06N 3/08; G06N 3/0481

(57) ABSTRACT

A computer implemented system for interpreting data using machine learning, including one or more processors; one or more memories; and one or more computer executable instructions embedded on the one or more memories, wherein the computer executable instructions are configured to execute a unified encoder comprising a neural network encoding data into one or more feature vectors, wherein the encoder is trained using machine learning to generate the one or more feature vectors useful for performing a plurality of different tasks each comprising different interpretations of the data. A plurality of decoders are connected to the unified encoder, each of the decoders comprising a neural network interpreting the one or more feature vectors so as to decode one or more of the feature vectors to output one of the interpretations.

### CROSS REFERENCE TO RELATED APPLICATIONS

This application claims the benefit under 35 U.S.C. Section 119(e) of co-pending and commonly-assigned U.S. provisional patent application Ser. No. 62/105,165, filed on Oct. 23, 2020, by Shreyansh Daftly, Annie K. Didier, Deegan J. Atha, Masahiro Ono, Chris A. Mattmann, and Zhanlin Chen, entitled “SULU: Scalable And Distributed Machine Learning Framework Based On A Unified Encoder,” client reference CIT-8544-P, which application is incorporated by reference herein.

### STATEMENT REGARDING FEDERALLY SPONSORED RESEARCH AND DEVELOPMENT

This invention was made with government support under Grant No. 80NMO0018D0004 awarded by NASA (JPL). The government has certain rights in the invention.

### BACKGROUND OF THE INVENTION

### 1. Field of the Invention

This invention relates to an encoder-decoder architecture for machine learning and artificial intelligence.

### 2. Description of the Related Art

A vast suite of machine-learning-based algorithms are being developed for a variety of applications. However, conventional algorithms are typically designed and trained to execute a single task, independently of other tasks, even when the tasks share similar inputs, representations, and model architectures. Simultaneously executing a plurality of independently trained models incurs unwanted redundancy and wastes precious computational resources, particularly for devices that require increased on board autonomy while having limited communication bandwidth. Furthermore, current algorithms do not exploit the power of deep neural networks to learn a generic and rich representation for all the tasks. Thus, there is a need to design and implement a modular, multitasking learning framework that can combine on board machine learning tasks into a unified distributed framework. The present disclosure satisfies this need.

### SUMMARY OF THE INVENTION

Embodiments of the inventive subject matter disclosed herein include, but are not limited to, the following.

1. A computer implemented system for interpreting data using machine learning, comprising:
one or more processors; one or more memories; and one or more computer executable instructions embedded on the one or more memories, wherein the computer executable instructions are configured to execute:
a (e.g., unified) encoder comprising a neural network encoding data into one or more feature vectors, wherein the encoder is trained using machine learning to generate the one or more feature vectors useful for performing a plurality of different tasks each comprising different interpretations of the data; and
a plurality of decoders connected to the unified encoder, each of the decoders comprising a neural network interpreting the one or more feature vectors so as to decode one or more of the feature vectors to output one of the interpretations.

2. The computer implemented system of example 1, wherein the different interpretations comprise at least one of a different classification or a conversion of the data into a different data format.

3. The system of example 1, wherein the data comprises first image data, and the different interpretations comprise at least one of text data, second image data, or semantic segmentation.

4. The system of example 1, wherein the different tasks comprise image captioning or natural language processing, semantic segmentation, and image reconstruction.

5. The system of any of the examples 1-3, wherein the encoder is trained using mutual transfer learning and the different tasks comprise commonalities or utilize shared information, e.g., text.

6. The system of any of the examples 1-5, wherein the encoder is trained using the machine learning comprising a first model for performing a first one of the tasks and a second model for performing a second one of the tasks, and a training of the encoder alternates between the first model and the second model after an epoch.

7. The system of any of the examples 1-6, wherein:
the computer system comprises a distributed network of the processors,
the encoder is modular so that the encoder can be transmitted between different ones of the processors and executed or trained on each of the different ones of the processors, and
the decoders can be executed on the different ones of the processors.

8. The system of example 1, wherein:
the data comprises an image;
the encoder executes a plurality of encoder convolution layers so as to output a first one of the feature vectors comprising an intermediate feature vector after a first plurality of the encoder convolution layers and a final feature vector after all the encoder convolution layers; and
one of the decoders comprises a semantic segmentation decoder executing a decoder convolution layer and deconvolution layers, the semantic segmentation decoder:
receives the intermediate feature vector and passing the intermediate feature vector through the decoder convolution layer to form a first output;
receives the final feature vector and passing the final feature vector through one a first one of the deconvolution layers to form a second output;
concatenates the first output and the second output to form a combined output;
passes the combined output through at least a second one of the deconvolution layers to form the one of the interpretations.

9. The system of example 8, wherein another one of the decoders comprises a natural language processing decoder:
receives only the final feature vector;
flattens the final feature vector to form a flattened feature vector;
passes the flattened feature vector through a fully connected layer to reduce the number of dimensions and form a reduced dimension feature vector;
concatenates the reduced dimension feature vector with a previous hidden state and previous hidden word, if necessary; to form a concatenated layer;
inputs the concatenated layer to a bidirectional GRU layer to form a GRU output; and
passes the GRU output through at least one fully connected layer so as to reduce the dimensions and form another of the interpretations comprising a word output.

10. The system of example 9, wherein another one of the decoders comprises an image reconstruction decoder:
successively deconvolutes the final feature vector through a plurality of deconvolution layers so as to reconstruct the data comprising an image.

11. The system of example 10, wherein hidden layers in the image reconstruction decoder and the semantic segmentation decoder are equipped with RELU activation.

12. The system of example 8, wherein the encoder comprises a spatial pyramid pooling layer after the convolution layers.

13. The system of any of the examples 1-12, wherein the different tasks comprise terrain classification and image captioning.

14. The system of any of the examples 1-13, wherein the encoder comprises a RES NET neural network, an Xception neural network, or a MobileNet neural network.

15. The system of any of the examples 1-14, further comprising a machine coupled to or including one of the processors, wherein the machine comprises a vehicle, an aircraft, a spacecraft, a weapon, a robot, a medical device (e.g., scope), an imaging device or camera, a rover, a sensor, an actuator, an intelligent agent, or a smart device in one or more smart buildings, wherein the machine utilizes one or more of the interpretations for operation of the machine.

16. The system of any of the examples 1-15, further comprising an apparatus coupled to or including one of the processors and utilizing the interpretations for operation of the apparatus, wherein the apparatus comprises at least one machine selected from a machine performing automated manufacturing, devices controlled by a control system, one or more devices used in banking, one or more devices supplying power or controlling power distribution, or one or more devices in an automotive or aerospace system.

17. The system of example 16, comprising a control system actuating motion of the machine in response to the interpretations.

18. The system of any of the examples 1-17, comprising a display displaying the interpretations and a camera for capturing the data comprising image data.

19. A method for interpreting data using machine learning, comprising:
training a (e.g., unified) encoder, comprising neural network, using one or more machine learning models, to generate one or more training feature vectors useful for performing a plurality of different tasks each comprising different interpretations of training data;
encoding new data, using the unified encoder, into one or more feature vectors, to generate the one or more feature vectors useful for performing the plurality of different tasks each comprising the different ones of the interpretations of the new data; and
interpreting the one or more feature vectors, using a plurality of decoders connected to the unified encoder, each of the decoders comprising a neural network outputting a different one of the interpretations of the new data.

20. The method of example 19, wherein the training comprises mutual transfer learning comprising propagating a gradient across orthogonal task specific parameter spaces.

### BRIEF DESCRIPTION OF THE DRAWINGS

Referring now to the drawings in which like reference numbers represent corresponding parts throughout:

FIG. 1. A system comprising an autonomous vehicle connected to a ground system and comprising a Scalable and distribUted machine Learning framework with Unified Encoder.

FIG. 2A. SULU framework and functional modalities.

FIG. 2B. SULU architecture.

FIG. 3A-3B. Various training methodologies, including sequential training (FIG. 3A) and alternate training (FIG. 3B).

FIGS. 4A-4K. Evaluation of the various training methodologies. FIG. 4A-4C illustrate a first method, wherein the encoder is sequentially trained first with SPOC and then with SCOTI, FIG. 4A shows SPOC performance, FIG. 4B shows SPOC confusion matrix, and FIG. 4C shows SCOTI performance, FIGS. 4D-4F illustrate a second method, wherein the encoder is sequentially trained with SCOTI and then with SPOC, FIG. 4D shows SPOC performance, FIG. 4E shows SPOC confusion matrix, and FIG. 4F shows SCOTI performance, FIGS. 4G-4I illustrate a third method wherein the encoder is alternately trained each epoch, FIG. 4G shows SPOC performance, FIG. 4H shows SPOC confusion matrix, and FIG. 4I shows SCOTI performance, and FIGS. 4J-4L illustrates a fourth method wherein the encoder is alternately trained each step, FIG. 4J shows SPOC performance, FIG. 4K shows SPOC confusion matrix, and FIG. 4L shows SCOTI performance.

FIG. 5. Validation performance of various unified encoder backbones for SPOC, SCOTT, and image reconstruction.

FIG. 6. Validation performance of various unified encoder backbones for terrain classification.

FIG. 7A-7E. System integration, test and deployment of the SULU architecture on an Athena Mars rover (FIG. 7A) over a 500 meter long autonomous traverse in an analog environment, and classification outputs (FIGS. 7B-7D) obtained from an image (FIG. 7E) captured by a camera on the rover.

FIG. 8. Performance of SULU with Arroyo Park and laboratory generated datasets.

FIG. 9A-9B. Examples of predictions using SULU.

FIG. 10. Example of sparse annotation and dense prediction using SULU.

FIG. 11. Tabulated data comparing SULU predictions with an independent prediction, for SULU trained using alternate training on terrestrial data from JPL Arroyo.

FIG. 12. Example distributed system including SULU.

FIG. 13. Flowchart illustrating a method of making SULU.

FIG. 14. Flowchart illustrating a method of interpreting data.

FIG. 15 is an exemplary hardware and software environment used to implement one or more embodiments of the invention.

FIG. 16 schematically illustrates a typical distributed/cloud-based computer system using a network to connect client computers to server computers during the implementation of SULU.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

Technical Description

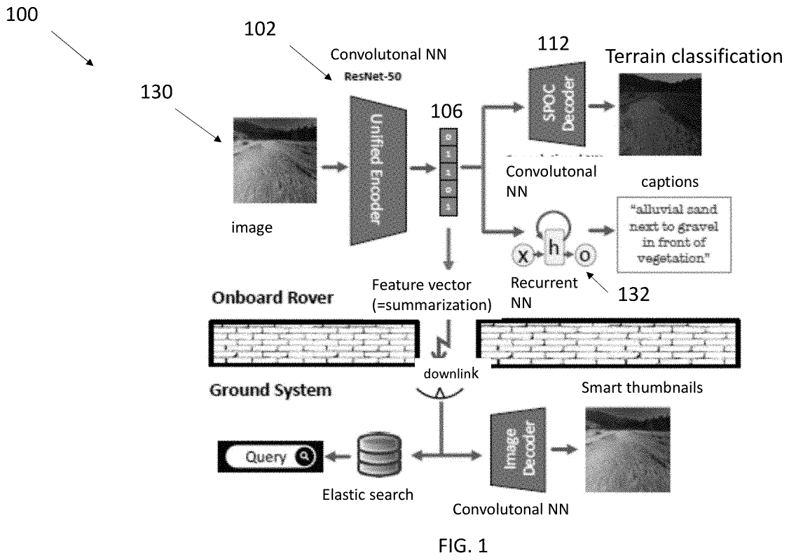

FIG. 1 illustrates a novel architecture comprising a Scalable and distribUted machine Learning framework with Unified encoder (SULU) which can be implemented in a remotely controlled device, an autonomous device, or other distributed system comprising a machine. The architecture can be implemented so as to remove redundancy and harness the power of mutual transfer learning for more efficient and more accurate inferences.

In order to maximally preserve the performance of each task, we unified the common components across multiple classifiers and convolutional auto encoders by examining the redundant information encoded across layers. All of the architectures have an encoder-decoder structure, where the encoders perform feature extraction, and the decoders interpret the features to carry out each functionality. Hence, the encoder for SULU is a unified encoder shared across all decoders. In one or more examples, by propagating the gradient along orthogonal, task-specific parameter spaces, the unified encoder can learn by extracting features required for each task without destructively interfering with the performance of other tasks [6]. In one or more examples, the unified encoder is a modification of DeepLabV3+ encoder and utilizes a spatial pyramid pooling layer [7]. Adding spatial pyramid pooling to the unified encoder enhances multi-level feature extraction, allowing the encoder to adapt to tasks that utilize fine and coarse features.

The following examples describe the architecture and its configurations, new multi-tasking training methodologies, and demonstration of applicability in various real-world scenarios. Although the examples illustrate the architecture as applied on a Mars rover including an on board computer performing multiple tasks such as terrain classification, image captioning, and image reconstruction, the architecture can be used for performing other tasks in other devices or systems,

### First Example: Architecture For Performing Image Processing, Captioning, and Semantic Segmentation

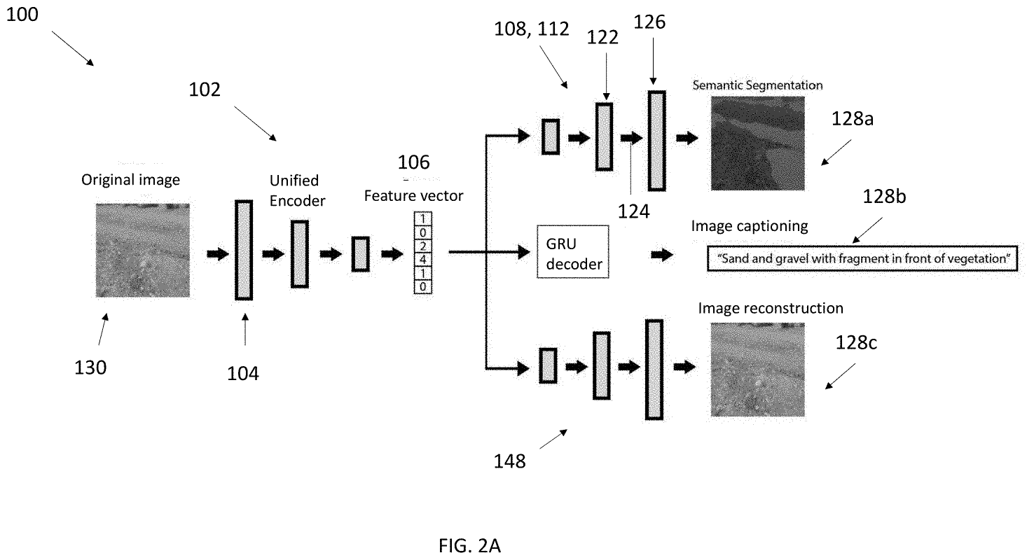

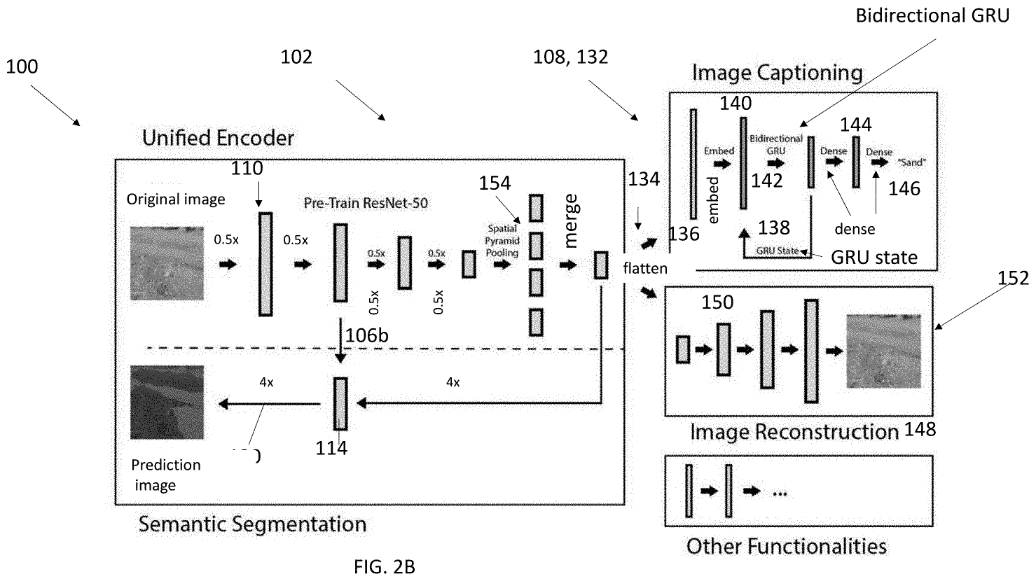

FIG. 2A-2B illustrate a SULU framework analysing an image to perform 3 tasks (semantic segmentation, image reconstruction, and image captioning). In this example, the input to SULU is a fixed size 512×512 red green blue (RGB) image. The pre-processing for each input image corresponds to the pre-processing of its encoder backbone. The input image is passed through stacks of convolutional layers. An intermediate feature vector of the encoder backbone was extracted as an atrous convolution input for the terrain classification decoder. The encoder backbone output was passed to convolutional layers at different resolutions and concatenated for the spatial pyramid pooling layer. The pooled layer was channeled into another convolutional layer, and the resulting final feature vector is used for all decoders.

The decoder for terrain classification uses a deep learning model known as Soil Property and Object Classification (SPOC) [5]. As illustrated in FIG. 2A-2B, the semantic segmentation decoder for terrain classification has two inputs: the intermediate and final feature vector from the unified encoder. The terrain classification decoder passes the intermediate feature vector through a convolutional layer and deconvolutes the final feature vector by up-sampling. Then, the two features are concatenated, and the combined feature is up-sampled back to 512×512 resolution by passing through two deconvolutional layers each with 256 channels.

The convolutional decoder for image reconstruction takes the final feature vector as input. The decoder successively deconvolutes and up-samples the final feature vector back to the original image dimension for output. For semantic segmentation and convolutional decoders, all hidden layers are equipped with rectified linear activation (RELU). The final layer in semantic segmentation is a soft-max layer, but the final layer in image reconstruction is a sigmoid layer.

The decoder for image captioning utilizes the deep learning model Scientific Captioning Of Terrain Images (SCOTI) [6]. The natural language processing decoder for image captioning only takes in the final feature vector from the unified encoder. The feature vector is first flattened and passed through a fully connected layer to reduce the number of dimensions. Then, the reduced feature vector is concatenated with the previous hidden state and the previous embedded word. The concatenated layer is used as input for the bidirectional Gated Recurrent Unit (GRU) layer with 128 units. The output of the GRU layer is passed through two fully connected layers, reducing the output dimension to fit the embedding layer for word output.

In this example, the unified encoder, SPOC decoder, SCOTI decoder, and image reconstruction decoder were implemented with Keras functional APT for modularization and layer sharing across each end-to-end model. Because there are different datasets for each task, errors are back propagated only to the corresponding encoder and decoder pair during training. A dam optimizer was used to adapt to the complex and dynamic training of recurrent units. Dropout layers were added to prevent overfitting during training. ImageNet pre-trained weights were used for transfer learning. Data for each model was split 90-10 for training and validation.

### Second Example: Sequential Training and Alternate Training of the Unified Encoder in the First Example

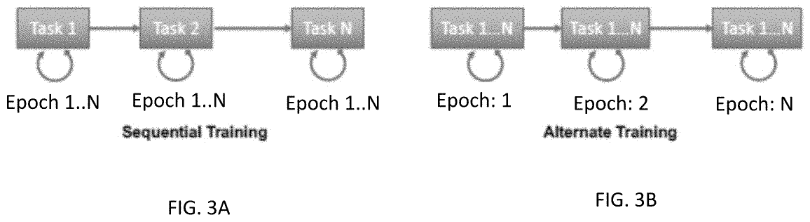

The unified encoder was trained for Terrain classification using SPOC and trained for image captioning using SCOTI. Several methods of multi-task learning were used to train the encoder with the models. FIG. 3A illustrates sequential training (Task 1−>Task 2−>. . . −>Task N). Early stopping monitoring validation loss was implemented during the training of sequential models to prevent overfitting. FIG. 3B illustrates alternate training, wherein all tasks are trained per epoch. In another alternate training method, a different model is trained every step.

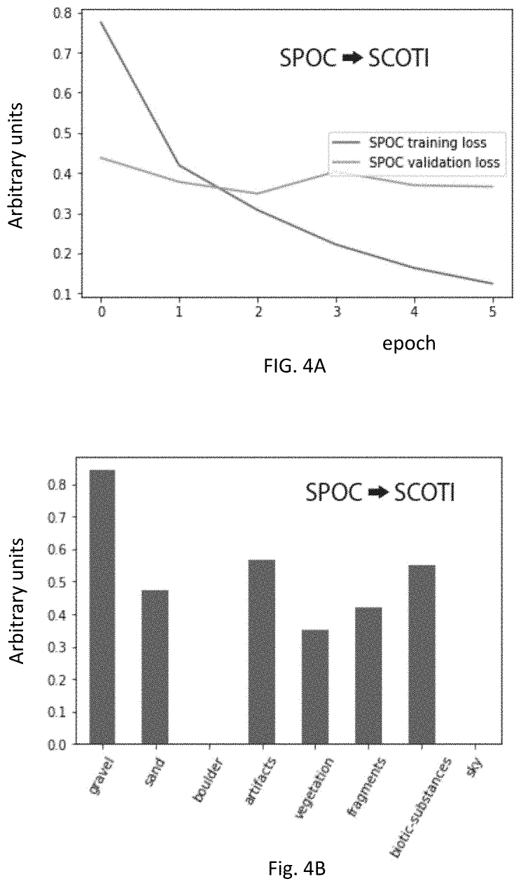

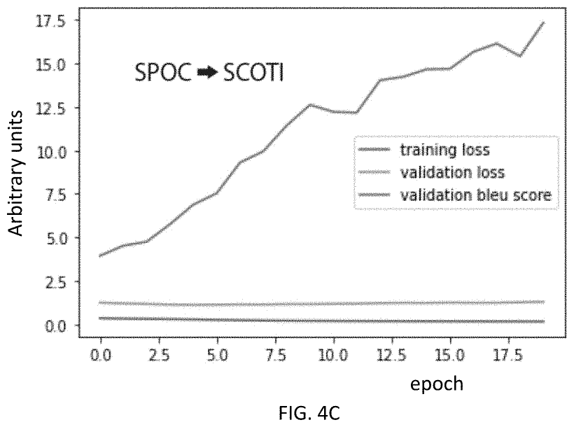

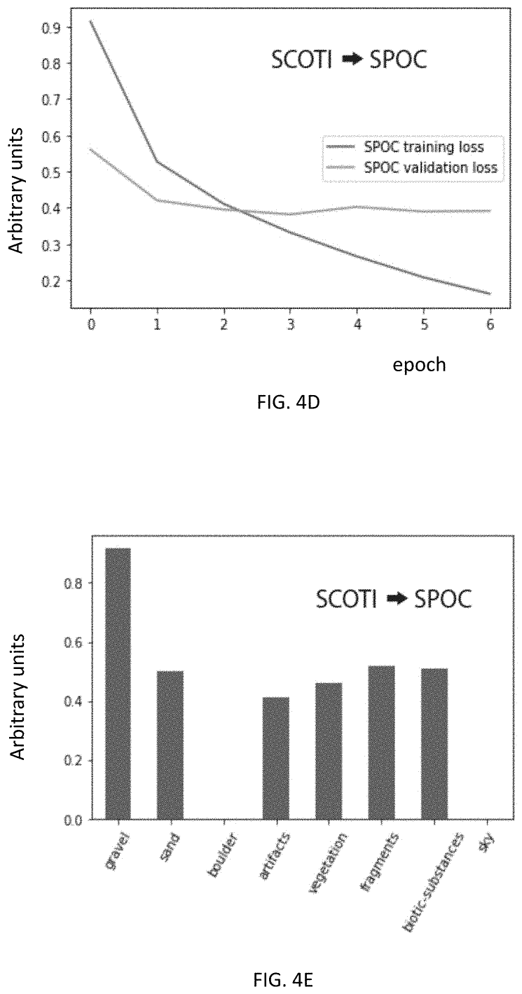

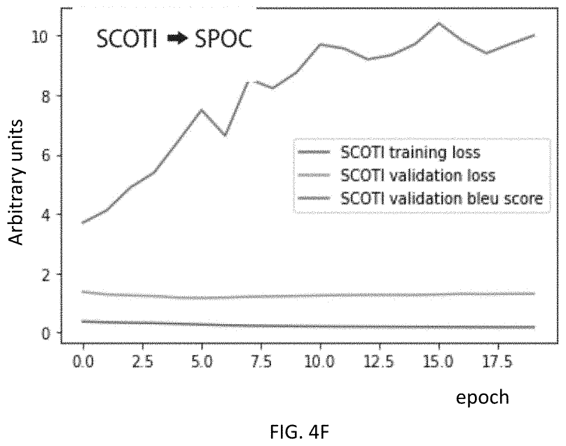

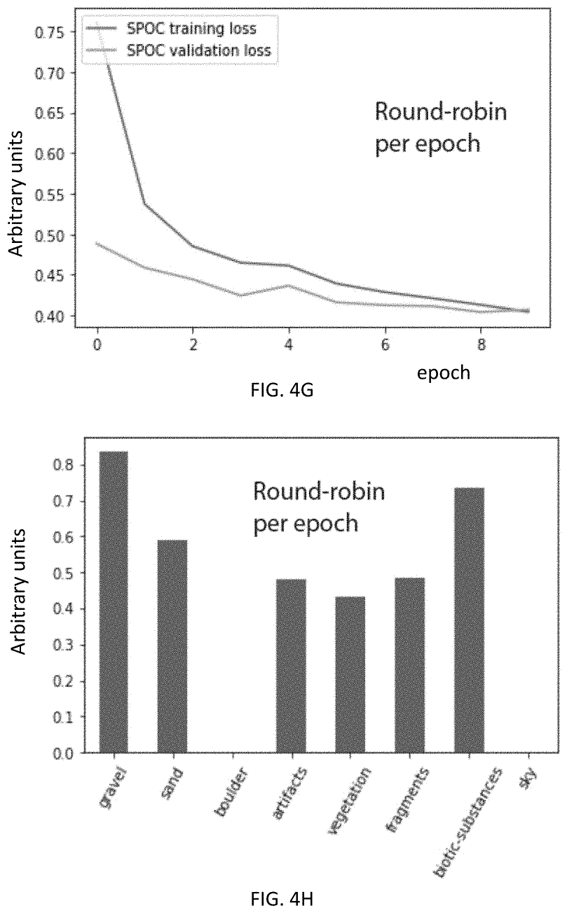

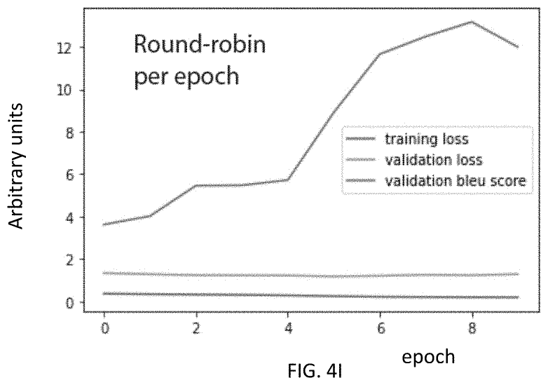

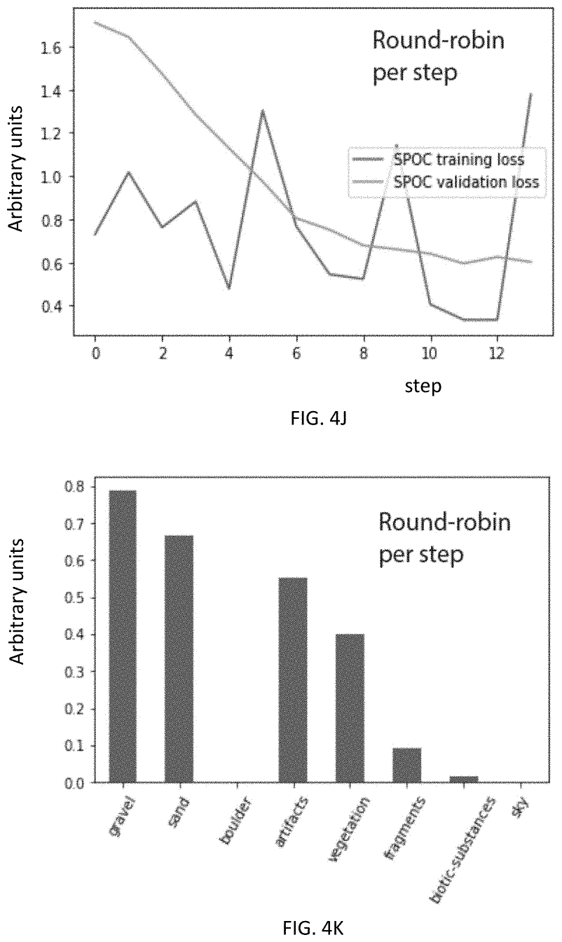

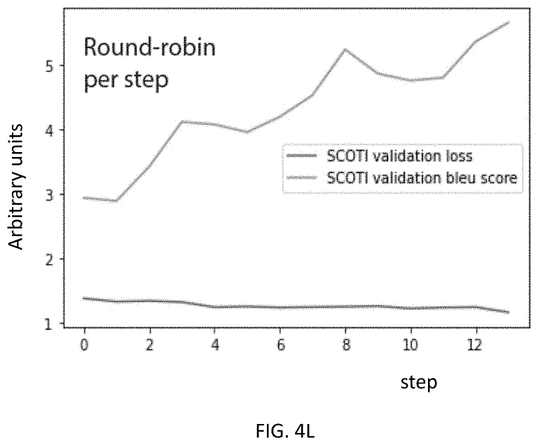

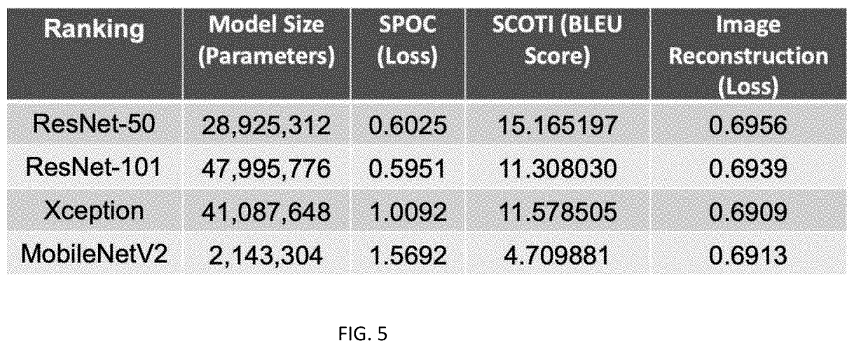

FIG. 4A-4L show the performance of each type of training methodology on a manually curated dataset from Arroyo Park, Pasadena, Calif. FIGS. 4A-4C illustrates a first method, wherein the encoder is sequentially trained first with SPOC and then with SCOTI. FIGS. 4D-4F illustrates a second method, wherein the encoder is sequentially trained with SCOTI and then with SPOC. FIGS. 4G-4I illustrates a third method wherein the encoder is alternately trained each epoch, and FIGS. 4J-4L illustrates a fourth method wherein the encoder is alternately trained each step. FIGS. 4A-4F show that the sequential training methods preferentially favoured the performance of the model that was last trained, which would bias performance in real-world situations. Specifically, the weights for the unified encoder were altered after training subsequent models. At the end, the weights were no longer compatible with the weights that produced the same output for the models trained initially, hence creating a bias and decreasing the performance. The fourth method (alternate training each step) was unstable and produced sub-optimal results in rare classes. The third method (alternate training, where all tasks are trained each epoch) produced the most stable results and maximized and balanced the performance across each task, especially when the SPOC training loss converged with the SPOC validation loss. Extrapolating the results from this benchmark for this application, additional models, such as the image reconstruction, should also be trained with the third method along with other models. A BLEU (bilingual evaluation understudy) algorithm was used for evaluating the quality of text which was outputted by the decoders.

### Third Example: Training the Unified Encoder of the First Example Using Multi-Task Transfer Learning

There are commonalities between terrain classification and image captioning. For example, the terrain identification describing the surrounding environment can provide nouns for captions. The shared information between these two tasks can be used to improve the training as compared to when these two tasks were trained independently.

Specifically, in one implementation of the training methodologies described in the second example, the unified encoder for image captioning is pre-trained with terrain classification in the first method, whereas the unified encoder for image captioning is not pre-trained in the second method. Between these two conditions, there was an improvement in the validation BLEU score when SULU is pre-trained with image captioning. Equally, the unified encoder for terrain classification is pre-trained with image captioning in the second method but not pre-trained in the first method. There was an improvement in the validation loss for terrain classification when the model is pre-trained with terrain classification.

In one or more examples, pre-training with terrain classification helps with image-captioning. Pre-training with image-captioning helps with terrain classification. However, if we pre-train the model for image-captioning, then train the model for terrain classification (sequentially), the model would forget image-captioning (the task it was pre-trained for) and perform very well at terrain classification. Similarly, if we pre-train the model for terrain classification, then train the model for image-captioning, then the model would also forget terrain-classification. Therefore, sequential training cannot retain the ability for the model to perform both tasks well, which warrants use of round-robin training strategies.

The third method, on the other hand, balances and retains the improvements from mutual transfer learning. Comparatively, the terrain classification and image captioning in the third method are better compared to terrain classification and image captioning without pre-training in the first method and in the second method, respectively. The improvement in performance supports our hypothesis on the information shared between these tasks and the mutually beneficial effects of training together.

Thus, in one or more examples, the training strategy comprises training the model for each task simultaneously rather than sequentially to avoid the model having significantly improved performance for the last trained task at the expense of the earlier trained tasks.

### Fourth Example: Testing of Unified Encoder Backbones

Four different types of encoder backbones were tested using the SULU framework of the First Example: ResNet-50, ResNet-101, MobileNetV2, Xception [8-10]. ResNet-101 and Xception are about 2× larger than ResNet-50 and, and MobileNetV2 is 10× smaller than ResNet-50. Larger models require more data to train. Encoder backbones were pre-trained with ImageNet, enabling transfer learning and reducing the data requirement. Exchanging the backbone can allow a trade-off between onboard computational resources and data availability and prediction quality.

FIG. 5 illustrates the size of the model and the performance of the predictions made by SULU. Xception outperformed other models in image reconstruction, and ResNet-101 outperformed other models in terrain classification. ResNet-50 performed better at image captioning compared to other models. MobileNetV2 trailed behind other models due to the limitation of its size and capacity. In one or more embodiments, ResNet-50 is used as the standard encoder backbone for compatibility with onboard computer modules and stability during training.

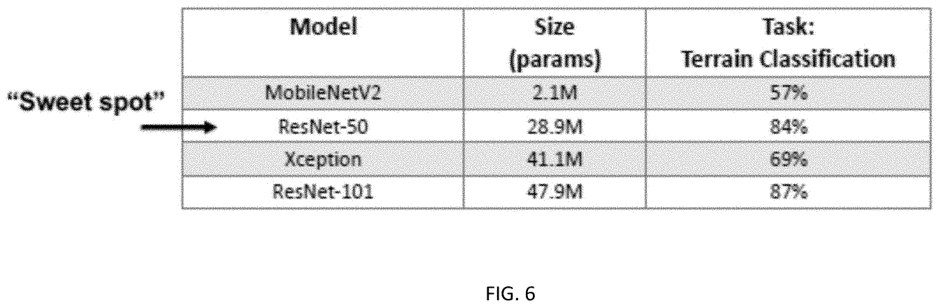

FIG. 6 illustrates the trade-off between model performance computation power for the unified encoder with different convolutional neural network (CNN) backbones, showing ResNet-50 works best for HPSC class avionics (tested on Nvidia TX2).

### Fifth Example: Working Examples Showing Application of the SULU Architecture of the First Example Interpreting Data in Real World Scenarios

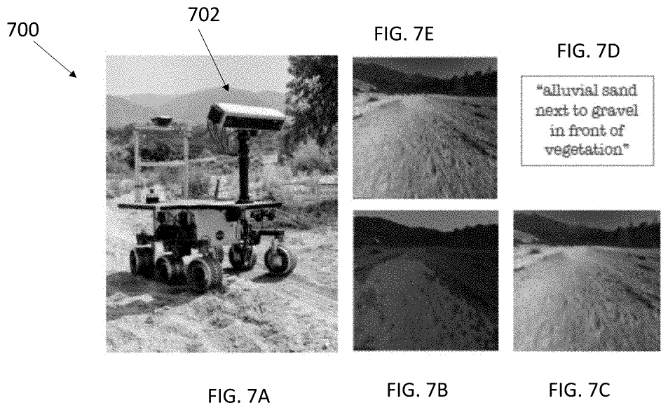

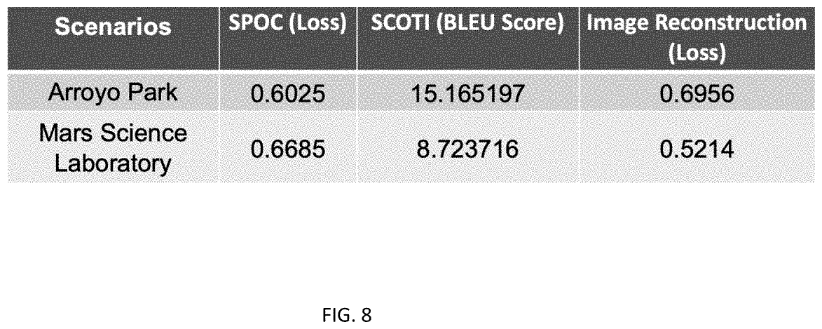

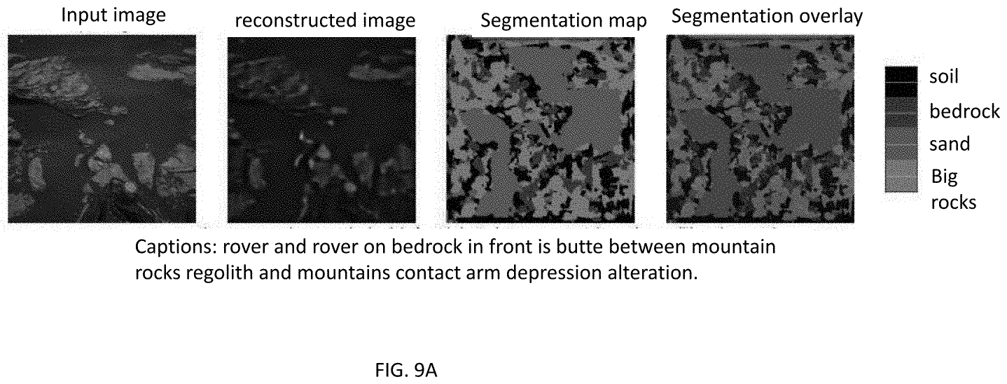

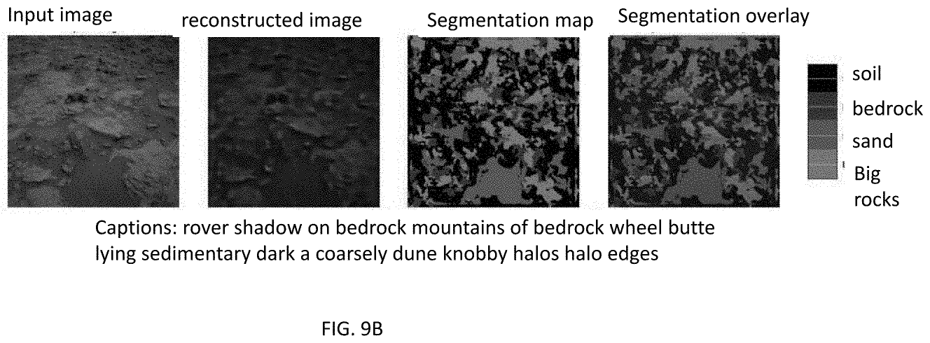

FIG. 7 illustrates an autonomous/remote control vehicle (Mars rover 700) including an on-board computer implementing SULU and a camera 702 for capturing images. The SULU on this rover was trained on real-world scenarios to demonstrate applicability. Our team manually curated a dataset from simulated rover trials at the Arroyo Park in Pasadena, Calif. In addition, we also used the Mars Science Laboratory (MSL) Navcam images with crowd-sourced terrain segmentation and Mars geologist captions. The performance for each dataset is shown in FIGS. 8 and 9.

Care was taken to evaluate the performance of the models based on the quantitative metrics in the absence of erroneous labelling artifacts. During the manual labelling process, the terrain was only categorized if the participant identified with high confidence. Otherwise, an area was not manually labelled even if in reality the terrain belongs to a category. While this method omits potential regions that could be used in the validation process, this conservative labelling strategy prevents false labelling.

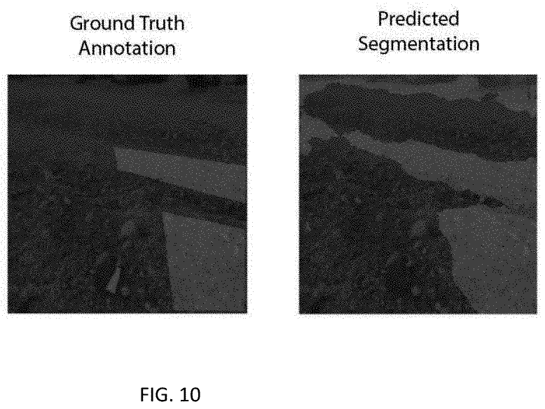

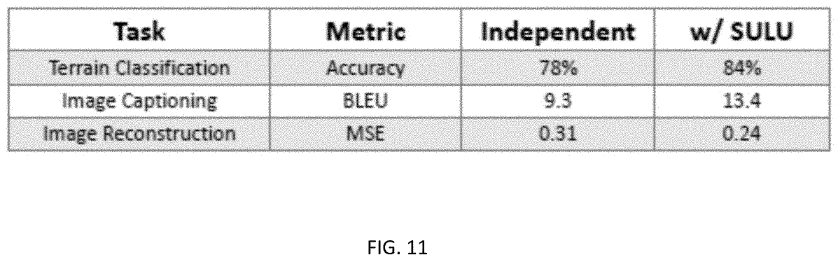

FIG. 10 shows that SULU inferences contain fine-grain labels that adhere closer to the ground-truth than human-generated labels. FIG. 11 shows tabulated results comparing SULU's predictions with that of an independent predictor (ground truth human generated labels) demonstrating that SULU improves overall performance of each task.

In some examples, care can be taken to avoid negatively quantifying (during the evaluation process) nuances of the model that improve the quality of the prediction. For example, curating a higher resolution dataset for validation can better quantify the quality of the predictions.

### Sixth Example: Distributed System Including SULU

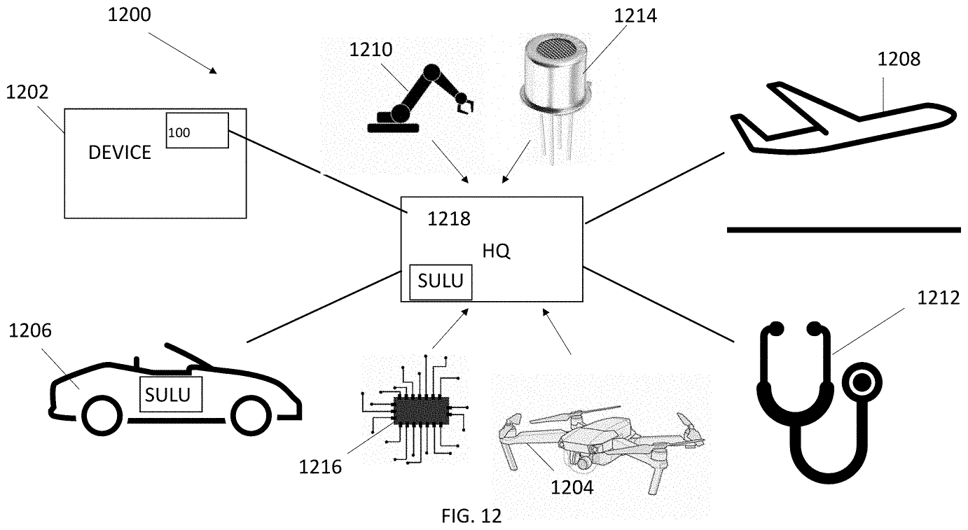

FIG. 12 illustrates a system 1200 including a machine 1202 coupled to or including a computer system implementing SULU (the unified encoder coupled to the decoders), wherein the machine 1202 comprises a drone 1204, a vehicle 1206, an aircraft 1208, a robot 1210, a medical device 1212 (e.g., scope), an imaging device or camera, a rover, a sensor 1214, a spacecraft, a satellite, an actuator, an intelligent agent, or a smart device 1216 or computer in one or more smart buildings, and wherein the machine utilizes one or more of the interpretations for operation of the machine. Further examples of the machine include, but are not limited to, a machine performing automated manufacturing, devices controlled by a control system or controller, or cloud computer 1218 or headquarter (HQ) or ground system, devices used in banking, mining, remote control devices supplying power or controlling power distribution, devices in an automotive or aerospace system, or devices used in health care, digital health, or health monitoring, or space exploration or space colonization, mining, exploration, reconnaissance.

Process Steps

A. Encoder-Decoder Architecture

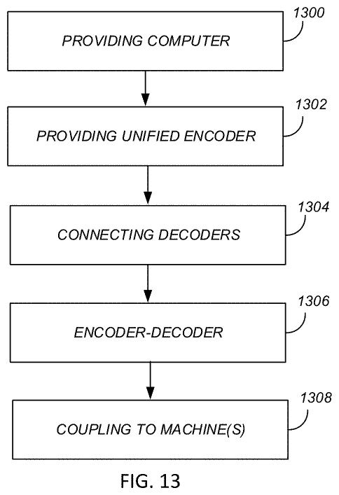

FIG. 13 is a flowchart illustrating a method for making a computer implemented system for interpreting data using machine learning.

Block 1300 represents providing a computer comprising one or more processors; one or more memories; and one or more programs stored in the one or more memories, wherein the one or more programs executed by the one or more processors execute an encoder-decoder architecture.

Block 1302 represents providing, on the computer, a unified encoder comprising a neural network encoding data into one or more feature vectors, wherein the encoder is trained using machine learning to generate the one or more feature vectors useful for performing a plurality of different tasks each comprising different interpretations of the data.

Block 1304 represents providing a plurality of decoders connected to the unified encoder, each of the decoders comprising a neural network interpreting the one or more feature vectors so as to decode one or more of the feature vectors to output one of the interpretations.

Block 1306 represents the end result, a computer implemented system for interpreting data using machine learning/artificial intelligence.

Block 1308 represents optionally coupling or connecting the system to a machine, e.g., in a distributed system or system as illustrated in FIG. 12.

Embodiments of the computer system include, but are not limited to, the following (referring also to FIGS. 1-16).

1. A computer implemented system 100, 1500, 1600 for interpreting data 130 using machine learning or artificial intelligence, comprising:
one or more processors 1504A, 1504B; one or more memories 1511; and one or more computer executable instructions 1510 embedded on the one or more memories 1511, wherein the computer executable instructions 1510 are configured to execute:
a unified encoder 102 comprising a neural network 104 encoding data 130 into one or more feature vectors 106, wherein the encoder 102 is trained using machine learning (e.g., one or more machine learning algorithms) to generate the one or more feature vectors 106 useful or configured for performing a plurality of different tasks each comprising different interpretations 128a, 128b, 128c of the data 130; and
a plurality of decoders 108 connected to the unified encoder 102, each of the decoders 108 comprising a neural network interpreting the one or more feature vectors 106 so as to decode one or more of the feature vectors 106 to output one of the interpretations 128a, 128b, 128c (see e.g., FIGS. 1-3C).

2. The computer implemented system of example 1, wherein the different interpretations 128a, 128b, 128c comprise at least one of a different classification or a conversion of the data into a different data format.

3. The system of example 1, wherein the data comprises first image data 130, and the different interpretations comprise at least one of text data 128b, second image data 128c, or semantic segmentation 128a.

4. The system of example 1, wherein the different tasks comprise image captioning or natural language processing, semantic segmentation, and image reconstruction.

5. The system of any of the examples 1-3, wherein the encoder 102 is trained using mutual transfer learning and the different tasks comprise commonalities or utilize shared information, e.g., text.

6. The system of any of the examples 1-5, wherein the encoder 102 is trained using the machine learning comprising a first model for performing a first one of the tasks and a second model for performing a second one of the tasks, and the training of the encoder alternates between the first model and the second model after an epoch.

6a. The system of any of the examples 1-5, wherein the machine learning comprises a model, and because the model can easily forget the previous task, the model is trained for each task one after another by alternating the epochs or at the same time (so as to avoid the model forgetting the task that it was previously trained for), as illustrated in FIG. 3B for example.

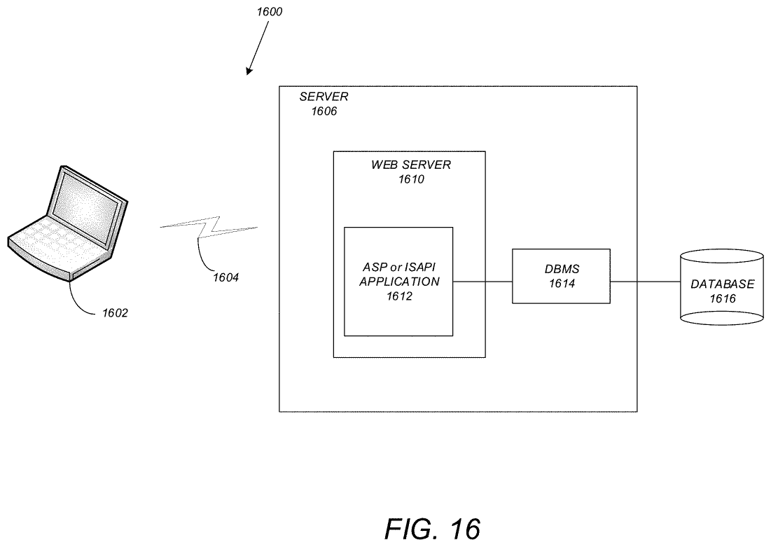

7. The system of any of the examples 1-6, wherein:
the computer system comprises a distributed network 1604 of the processors 1504A, 1504B, see e.g., FIG. 16),
the unified encoder 102 is modular so that the encoder can be transmitted between the different ones of the processors and executed or trained on each of the different ones of the processors, and
the decoders 108 can be executed on different ones of the processors.

8. The system of example 1, wherein:
the data 130 comprises an image;
the unified encoder 102 executes a plurality of encoder convolution layers 110 so as to output a first one of the feature vectors 106 comprising an intermediate feature vector 106b after a first plurality of the encoder convolution layers 110 and a final feature vector 106c after all the encoder convolution layers 110; and
one of the decoders comprises a semantic segmentation decoder 112 executing a decoder convolution layer 114 and deconvolution layers 116, the semantic segmentation decoder 112:
receives the intermediate feature vector 106b and passes the intermediate feature vector 106b through the decoder convolution layer 114 to form a first output 120;
receives the final feature vector 106c and passing the final feature vector 106c through one a first one of the deconvolution layers 122 to form a second output 124;
concatenates the first output 120 and the second output 124 to form a combined output 125;
passes the combined output 125 through at least a second one of the deconvolution layers 126 to form the one of the interpretations 128a.

9. The system of example 8, wherein another one of the decoders comprises a natural language processing decoder 132:
receives only the final feature vector 106;
flattens 134 the final feature vector to form a flattened feature vector;
passes the flattened feature vector through a fully connected layer 136 to reduce the number of dimensions and form a reduced dimension feature vector;
concatenates the reduced dimension feature vector with a previous hidden state 138 and previous hidden word, if necessary; to form a concatenated layer 140;
inputs the concatenated layer to a bidirectional GRU layer 142 to form a GRU output;
passes the GRU output through at least one fully connected layer 144 so as to reduce the dimensions and form another of the interpretations 128b comprising a word output 146.

10. The system of example 9, wherein another one of the decoders 108 comprises an image reconstruction decoder 148:
successively deconvolutes the final feature vector 106c through a plurality of deconvolution layers 150 so as to reconstruct the data comprising an image 152.

11. The system of example 10, wherein hidden layers in the image reconstruction decoder 148 and the semantic segmentation decoder 112 are equipped with RELU activation.

12. The system of example 8, wherein the unified encoder 102 comprises a spatial pyramid pooling layer 154 after the convolution layers 110.

13. The system of any of the examples 1-12, wherein the different tasks comprise terrain classification and image captioning.

14. The system of any of the examples 1-13, wherein the unified encoder 102 comprises a RES NET neural network, an Xception neural network, or a MobileNet neural network.

15. The system of any of the examples 1-14, further comprising a machine 1202 coupled to or including one of the processors, wherein the machine comprises a vehicle 1206, an aircraft 1208, a spacecraft, a weapon, a robot 1210, a medical device 1212 (e.g., scope), an imaging device or camera, a rover 700 (e.g., configured to drive on a planet or extraterrestrial surface), a sensor 1214, an actuator, an intelligent agent 1216, or a smart device in one or more smart buildings, wherein the machine 1202 utilizes one or more of the interpretations 128a, 128b, 128c for operation of the machine (see e.g., FIG. 12).

16. The system of any of the examples 1-15, further comprising an apparatus 1202 coupled to or including one of the processors and utilizing the interpretations for operation of the apparatus, wherein the device comprises at least one machine selected from a machine performing automated manufacturing 1210, devices controlled by a control system, devices used in banking, devices supplying power or controlling power distribution, or devices in an automotive or aerospace system (see e.g., FIG. 12).

17. The system of example 16, comprising a control system actuating motion of the machine in response to the interpretations 128a, 128b, 128c.

18. The system of any of the examples 1-17, comprising one or more displays 1522 displaying the interpretations (e.g., the text data, semantic segregation images and data, and reconstructed images) and a camera 702 for capturing the image data.

B. Method of Interpreting

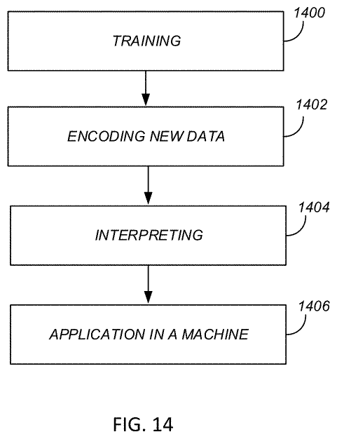

FIG. 14 is a flowchart illustrating a method of interpreting data using machine learning.

Block 1400 represents training a unified encoder, comprising neural network, using one or more machine learning models, to generate one or more feature vectors useful for performing a plurality of different tasks each comprising different interpretations of training data. In one or more examples, the training comprises mutual transfer learning comprising propagating a gradient across orthogonal task specific parameter spaces. In one or more examples, the encoder is trained using the machine learning comprising a first model for performing a first one of the tasks and a second model for performing a second one of the tasks, and the training alternates between the first model and the second model after an epoch. In one or more examples, because the model can easily forget the previous task, the model is trained for each task one after another by alternating the epochs or at the same time (so as to avoid the model forgetting the task that it was previously trained for).

Block 1402 represents encoding new data, using the unified encoder, into one or more feature vectors, to generate the one or more feature vectors useful for performing the plurality of different tasks each comprising the different interpretations of the new data.

Block 1404 represents interpreting the one or more feature vectors, using a plurality of decoders connected to the unified encoder, each of the decoders comprising a neural network outputting a different one of the interpretations of the new data.

Block 1406 represents optionally using the interpretations in a machine or application, e.g., as illustrated in FIG. 12.

19. The method can be implemented using the encoder decoder architecture of any of the examples 1-18 above.

20. The method or system of any of the examples 1-19, comprising a vehicle (e.g., planetary rover, car, truck) or aircraft (e.g., drone) connected to the one or more processors implementing the unified encoder and the decoders, the vehicle comprising or coupled to a navigation system and a propulsion system, wherein:
(1) the data comprises first image data captured by a camera on the vehicle, and the different interpretations comprise at least one of natural language processing and semantic segmentation,

(2) the semantic segmentation comprises soil property and object classification including terrain type (e.g., sand, bedrock) and terrain features (e.g., gradient, slopes, contours, scarps, and/or ridges) and a navigation system selects a trajectory using the soil property and object classification by avoiding obstacles identified by the soil property and object classification, and
(3) the natural language processing outputs text data used to search images captured by the camera, caption the images, provide navigation instructions to the navigation system, or interface/communicate with a human.

21. The method or system of any of the examples 1-19, comprising a satellite or spacecraft connected to the one or more processors implementing the unified encoder and the decoders, the satellite comprising or coupled to a navigation system, a propulsion system, and a camera;
(1) the data comprises first image data of a planet (e.g., atmosphere and/or surface) captured using the camera and the different interpretations comprise semantic segmentation and natural language processing,
(2) the semantic segregation comprises identification of at least one of weather or soil property and object classification of features captured in the first image data, and
(3) the natural language processing outputs text data used to search images captured by the camera, caption the images, provide navigation to the navigation system controlling the trajectory and/or orientation of the satellite or positioning of the camera, select images for download to a ground system, or interface/communicate with a human.

22. The method or system of any of the examples 1-19, wherein:
(1) the machine coupled to the processors comprises a medical device or diagnostic tool (e.g., scope) comprising a camera, coupled to the one or more processors implementing the unified encoder and decoders,
(2) the data comprises first image data of human or animal tissue captured by a camera on the scope or medical device, and the different interpretations comprise at least one of natural language processing and semantic segmentation,
(3) the semantic segmentation comprises identification of types of tissue, diseased, and non-diseased areas, and the medical device treats or outputs data used to treat the human or animal tissue.
(4) the natural language processing outputs text data used to search images captured by the camera, caption the images, provide instructions controlling movement of the scope relative to the tissue, or interface/communicate with a human operator of the medical device.

23. The method or system of any of the examples 1-19, wherein:
(1) the machine coupled to the processors comprises a manufacturing tool (e.g., 3D printer) or robot comprising a camera, coupled to the one or more processors implementing the unified encoder and decoders,
(2) the data comprises first image data of an environment of the robot or tool, or a workpiece being worked on by the tool or robot, the image captured by a camera on the robot or tool, the different interpretations comprise at least one of natural language processing and semantic segmentation,
(3) the semantic segmentation comprises identification of types of material, objects, persons, or contours of the environment or the workpiece captured in the image data,
(4) the natural language processing outputs text data used to search images captured by the camera, caption the images, provide navigation or manipulation instructions to a control system or actuator controlling movement or the tool or robot, or interface/communicate with a human.

24. The method or system of any of the examples 1-19, wherein:
(1) the machine coupled to the processors comprises a computer system or control system or monitoring system comprising a camera, coupled to the one or more processors implementing the unified encoder and decoders,
(2) the data comprises first image data of an environment of the computer system, the image captured by a camera on the robot or tool, the different interpretations comprise at least one of natural language processing and semantic segmentation,
(3) the semantic segmentation comprises identification or recognition of types of material, objects, persons (e.g., facial recognition), or contours of the environment captured in the image data,
(4) the natural language processing outputs text data used to search images captured by the camera, caption the images, provide instructions to the control system or actuator controlled by the control system, or interface/communicate with a human.

25. The method or system of any of the examples 1-19, wherein:
a machine coupled to or including one of the processors, comprises a vehicle, an aircraft, a spacecraft, a satellite, a weapon, a security system, a robot, a medical device (e.g., scope), an imaging device or camera, a rover, a sensor, an actuator, an intelligent agent, a smart device in one or more smart buildings, or a computer, a tool (e.g., 3D printer), a drone (e.g., performing delivery services of goods, reconnaissance, surveying, mapping, remote sensing, or exploration) wherein:
(1) the data comprises first image data of an environment of the machine or a workpiece which the machine is manipulating, the first image data captured by a camera on the machine, and the different interpretations comprise at least one of text data and semantic segmentation,
(2) the semantic segmentation comprises identification of types of material, objects, persons, or contours of the environment,
(3) the text data is used to search images captured by the camera, caption the images, provide navigation or instructions to the machine, or interface/communicate with a human operator of the machine.

26. The method or system of any of the examples 1-26, wherein the machine comprises a drone or vehicle performing delivery services of goods, mapping, exploration.

27. The method or system of any of the examples 1-25, wherein the machine comprises a computer performing data mining and the data mining comprises the semantic segmentation and the image captioning.

28. The method or system of any of the examples 1-25, wherein the machine comprises a vehicle or aircraft performing reconnaissance, exploration, mapping, or surveying, and the mapping data, reconnaissance data, exploration data comprises the semantic segmentation and the image captioning.

29. The method or system of any of the examples 1-28, wherein the processors implementing the encoder and the decoders improve the functioning of the computer system by:
(1) using mutual transfer learning to reduce redundancy (and reduce execution of the number algorithms) in training of the unified encoder for performing multiple different tasks; and
(2) distributing execution of the decoders over a plurality of computers so as to reduce memory and processing requirements of each of the computers in the network and in particular for on-board computers on smaller remote devices or machines operating using the unified encoder.

30. The method or system of any of the examples 1-29, wherein the computer system comprising the unified encoder shared between multiple decoders comprises a novel and inventive distribution of functionality within the computer system and a novel structure within the computer system.

31. The system or method of any of the examples described herein, including of any of the examples 1-27, integrated into a practical application (e.g., a computer implemented mapping system, navigation system, control system, data mining or data analysis system, surveying system, diagnostic system, or computer system, or other applications described herein) and improve functioning of the computers implementing the methods or systems or the devices and machines using data outputted from the methods or systems.

32. The computer implemented system or method of any of the preceding examples 1-31, comprising activating or utilizing the method or system in real-time, e.g., to provide navigation, data analysis, data mining, remote sensing, mapping, or control instructions, or any of the functionalities described herein, in a real-world environment.

33. A navigation system or application or mapping system or remote sensing, or application comprising the system of any of the examples.

34. A method of performing multiple tasks with a special encoder-decoder architecture of any of the examples and specifically designed learning procedures.

35. The method or system of any of the examples 1-34, wherein the encoder 102 comprises a convolutional neural network (e.g., resnet [12]), the semantic segmentation decoder 112 comprises a convolutional neural network (e.g., SPOC [5]), the image reconstruction decoder 148 comprises a convolutional neural network, and the natural language processing decoder 132 comprises a recurrent neural network (e.g., SCOTI [6]).

Advantages and Improvements

The present disclosure describes a new architecture, SULU, for multi-task learning applicable to a wide variety of application scenarios. By modularizing the encoder-decoder components, multiple tasks can be trained independently. Mutual transfer learning improved the performance of the SULU. Because the unified encoder is modularized, the encoder backbone can be swapped out, allowing a trade-off between memory footprint and performance depending on the hardware capabilities. Pre-trained weights were used for the encoder backbones to overcome data limitations.

In one or more examples, the modularized framework can be distributed across different systems to offload processing power from the embedded system. By running the unified encoder onboard an autonomous or remote controlled vehicle, such as a Mars rover, feature vectors can be used for terrain classification. However, the unified encoder can also be transmitted back to mission headquarters for multiple types of post-processing and signal reconstruction. A suite of applications can be integrated into the SULU architecture.

While multi-task learning is still a field with ongoing research, our results show that each model in our SULU framework may learn at different rates due to data availability, and in some examples, synchronizing the progress still requires manual tuning of the training parameters. By co-ordinating the training, there was an improvement in the jointly trained model as compared to models trained separately. However, the SULU framework provides a platform for testing hypotheses on multi-task learning. In one or more examples, investigations of the relationship between various tasks in the SULU framework can be used to elucidate the effects of mutual transfer learning.

Hardware Environment

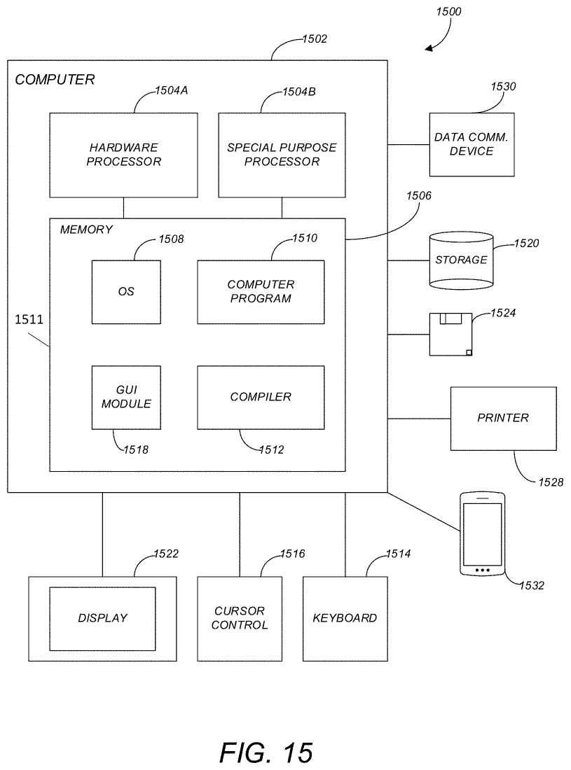

FIG. 15 is an exemplary hardware and software environment 1500 (referred to as a computer-implemented system and/or computer-implemented method) used to implement one or more embodiments of the invention. The hardware and software environment includes a computer 1502 comprising a logical circuit or circuitry and may include peripherals. Computer 1502 may be a user/client computer, server computer, or may be a database computer. The computer 1502 (e.g., logical circuit) comprises one or more processors, e.g., a hardware processor 1504A and/or a special purpose hardware processor 1504B (hereinafter alternatively collectively referred to as processor 1504) and a memory 1506, such as random access memory (RAM). The computer 1502 may be coupled to, and/or integrated with, other devices, including input/output (I/O) devices such as a keyboard 1514, a cursor control device 1516 (e.g., a mouse, a pointing device, pen and tablet, touch screen, multi-touch device, etc.) and a printer 1528. In one or more embodiments, computer 1502 may be coupled to, or may comprise, a portable or media viewing/listening device 1532 (e.g., an MP3 player, IPOD, NOOK, portable digital video player, cellular device, personal digital assistant, etc.). In yet another embodiment, the computer 1502 may comprise a multi-touch device, mobile phone, gaming system, internet enabled television, television set top box, or other internet enabled device executing on various platforms and operating systems.

In one embodiment, the computer 1502 operates by the hardware processor 1504A performing instructions defined by the computer program 1510 (e.g., a computer-aided design [CAD] application) under control of an operating system 1508. The computer program 1510 and/or the operating system 1508 may be stored in the memory 1506 and may interface with the user and/or other devices to accept input and commands and, based on such input and commands and the instructions defined by the computer program 1510 and operating system 1508, to provide output and results.

Output/results may be presented on the display 1522 or provided to another device for presentation or further processing or action. In one embodiment, the display 1522 comprises a liquid crystal display (LCD) having a plurality of separately addressable liquid crystals. Alternatively, the display 1522 may comprise a light emitting diode (LED) display having clusters of red, green and blue diodes driven together to form full-color pixels. Each liquid crystal or pixel of the display 1522 changes to an opaque or translucent state to form a part of the image on the display in response to the data or information generated by the processor 1504 from the application of the instructions of the computer program 1510 and/or operating system 1508 to the input and commands. The image may be provided through a graphical user interface (GUI) module 1518. Although the GUI module 1518 is depicted as a separate module, the instructions performing the GUI functions can be resident or distributed in the operating system 1508, the computer program 1510, or implemented with special purpose memory and processors.

In one or more embodiments, the display 1522 is integrated with/into the computer 1502 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1502 according to the computer program 1510 instructions may be implemented in a special purpose processor 1504B. In this embodiment, some or all of the computer program 1510 instructions may be implemented via firmware instructions stored in a read only memory (ROM), a programmable read only memory (PROM) or flash memory within the special purpose processor 1504B or in memory 1506. The special purpose processor 1504B may also be hardwired through circuit design to perform some or all of the operations to implement the present invention. Further, the special purpose processor 1504B may be a hybrid processor, which includes dedicated circuitry for performing a subset of functions, and other circuits for performing more general functions such as responding to computer program 1510 instructions. In one embodiment, the special purpose processor 1504B is an application specific integrated circuit (ASIC) or Field Programmable Gate Array (FPGA).

The computer 1502 may also implement a compiler 1512 that allows an application or computer program 1510 written in a programming language such as C, C++, Assembly, SQL, PYTHON, PROLOG, MATLAB, RUBY, RAILS, HASKELL, or other language to be translated into processor 1504 readable code. Alternatively, the compiler 1512 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1510 accesses and manipulates data accepted from I/O devices and stored in the memory 1506 of the computer 1502 using the relationships and logic that were generated using the compiler 1512.

The computer 1502 also optionally comprises an external communication device such as a modem, satellite link, Ethernet card, or other device for accepting input from, and providing output to, other computers 1502.

In one embodiment, instructions implementing the operating system 1508, the computer program 1510, and the compiler 1512 are tangibly embodied in a non-transitory computer-readable medium, e.g., data storage device 1520, which could include one or more fixed or removable data storage devices, such as a zip drive, floppy disc drive 1524, hard drive, CD-ROM drive, tape drive, etc. Further, the operating system 1508 and the computer program 1510 are comprised of computer program 1510 instructions which, when accessed, read and executed by the computer 1502, cause the computer 1502 to perform the steps necessary to implement and/or use the present invention or to load the program of instructions into a memory 1506, thus creating a special purpose data structure causing the computer 1502 to operate as a specially programmed computer executing the method steps described herein. Computer program 1510 and/or operating instructions may also be tangibly embodied in memory 1506 and/or data communications devices 1530, thereby making a computer program product or article of manufacture according to the invention. As such, the terms “article of manufacture,” “program storage device,” and “computer program product,” as used herein, are intended to encompass a computer program accessible from any computer readable device or media.

In one or more examples, the one or more processors, memories, and/or computer executable instructions are specially designed, configured or programmed for performing machine learning. The computer program instructions may include a pattern matching component for pattern recognition (e.g., semantic segregation, natural language processing/image captioning, and/or image reconstruction) or applying a machine learning model (e.g., for analysing data or training data input from a data store to perform the semantic segregation, the image reconstruction, and natural language processing/image captioning). In one or more examples, the processors may comprise a logical circuit for performing pattern matching or recognition, or for applying a machine learning model for analysing data or train data input from a memory/data store or other device (e.g., an image from a camera). Data store/memory may include a database.

In some examples, the pattern matching model applied by the pattern matching logical circuit may be a machine learning model, such as a convolutional neural network, a logistic regression, a decision tree, or other machine learning model. In one or more examples, the logical circuit comprises a semantic segregation logical circuit, a natural language processing/image captioning logical circuit, and an image reconstruction logical circuit.

Of course, those skilled in the art will recognize that any combination of the above components, or any number of different components, peripherals, and other devices, may be used with the computer 1502.

FIG. 16 schematically illustrates a typical distributed/cloud-based computer system 1600 using a network 1604 to connect client computers 1602 to server computers 1606. A typical combination of resources may include a network 1604 comprising the Internet, LANs (local area networks), WANs (wide area networks), SNA (systems network architecture) networks, or the like, clients 1602 that are personal computers or workstations (as set forth in FIG. 15), and servers 1606 that are personal computers, workstations, minicomputers, or mainframes (as set forth in FIG. 15). However, it may be noted that different networks such as a cellular network (e.g., GSM [global system for mobile communications] or otherwise), a satellite based network, or any other type of network may be used to connect clients 1602 and servers 1606 in accordance with embodiments of the invention.

A network 1604 such as the Internet connects clients 1602 to server computers 1606. Network 1604 may utilize Ethernet, coaxial cable, wireless communications, radio frequency (RF), etc. to connect and provide the communication between clients 1602 and servers 1606. Further, in a cloud-based computing system, resources (e.g., storage, processors, applications, memory, infrastructure, etc.) in clients 1602 and server computers 1606 may be shared by clients 1602, server computers 1606, and users across one or more networks. Resources may be shared by multiple users and can be dynamically reallocated per demand. In this regard, cloud computing may be referred to as a model for enabling access to a shared pool of configurable computing resources.

Clients 1602 may execute a client application or web browser and communicate with server computers 1606 executing web servers 1610. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1602 may be downloaded from server computer 1606 to client computers 1602 and installed as a plug-in or ACTIVEX control of a web browser. Accordingly, clients 1602 may utilize ACTIVEX components/component object model (COM) or distributed COM (DCOM) components to provide a user interface on a display of client 1602. The web server 1610 is typically a program such as MICROSOFT'S INTERNET INFORMATION SERVER.

Web server 1610 may host an Active Server Page (ASP) or Internet Server Application Programming Interface (ISAPI) application 1612, which may be executing scripts. The scripts invoke objects that execute business logic (referred to as business objects). The business objects then manipulate data in database 1616 through a database management system (DBMS) 1614. Alternatively, database 1616 may be part of, or connected directly to, client 1602 instead of communicating/obtaining the information from database 1616 across network 1604. When a developer encapsulates the business functionality into objects, the system may be referred to as a component object model (COM) system. Accordingly, the scripts executing on web server 1610 (and/or application 1612) invoke COM objects that implement the business logic. Further, server 1606 may utilize MICROSOFT'S TRANSACTION SERVER (MTS) to access required data stored in database 1616 via an interface such as ADO (Active Data Objects), OLE DB (Object Linking and Embedding DataBase), or ODBC (Open DataBase Connectivity).

Generally, these components 1600-1616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1602 and 1606 may be interchangeable and may further include thin client devices with limited or full processing capabilities, portable devices such as cell phones, smart phones, notebook computers, laptop computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1602 and 1606. Embodiments of the invention are implemented as a software/CAD application on a client 1602 or server computer 1606. Further, as described above, the client 1602 or server computer 1606 may comprise a thin client device or a portable device that has a multi-touch-based display.

### REFERENCES

The following references are incorporated by reference herein

[1] A. Alhilal, T. Braud, and P. Hui, “The Sky is NOT the Limit Anymore: Future Architecture of the interplanetary Internet,” IEEE Aerospace and Electronic Systems Magazine, vol. 34, no. 8, pp. 22-32, 20I9, doi: I0.II09/maes.20I9.2927897.

[2] Y. Y. Krikorian, D. L. Emmons, and J. P. McVey, “Communication coverage and cost of the deep space network for a Mars manned flyby mission,” in 2005 IEEE Aerospace Conference, 2005: TEEE, pp. I670-I677.

[3] G. Lentaris et al., “High-performance embedded computing in space: Evaluation of platforms for vision-based navigation,” Journal of Aerospace Information Systems, vol. 15, no. 4, pp. 178-192, 20I8.

[5] B. Rothrock, R. Kennedy, C. Cunningham, J. Papon, M. Heverly, and M. Ono, “SPOC: Deep Learning-based Terrain Classification for Mars Rover Missions,” AlAA SPACE 2016, 2016, doi: I0.25I4/6.20I6-5539.

[6] D. Qiu et al., “SCOTI: Science Captioning of Terrain Images for data prioritization and local image search,” Planetary and Space Science, vol. I88, p. I04943, 2020 2020, doi: I0.I0I6/j.pss.2020.I04943.

[7] T. Yu, S. Kumar, A. Gupta, S. Levine, K. Hausman, and C. Finn, “Gradient surgery for multi-task learning,” arXiv preprint arXiv: 2001.06782, 2020.

[8] L.-C. Chen, Y. Zhu, G. Papandreou, F. Schroff, and H. Adam, “Encoder-decoder with atrous separable convolution for semantic image segmentation,” in Proceedings of the European conference on computer vision (ECCV), 2018, pp. 801-818.

[9] F. Chollet, “Xception: Deep learning with depthwise separable convolutions,” in Proceedings of the IEEE conference on computer vision and pattern recognition, 2017, pp. 125I-1258.

[10] K. He, X. Zhang, S. Ren, and J. Sun, “Deep residual learning for image recognition,” in Proceedings of the IEEE conference on computer vision and pattern recognition, 20I6, pp. 770-778.

[11] A. G. Howard et al., “Mobilenets: Efficient convolutional neural networks for mobile vision applications,” arXiv preprint arXiv: 1704.0486.1, 2017

[12] Resnet https://www.mathworks.com/help/deeplearning/ref/resnet50.html

Conclusion

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented system for interpreting data using machine learning, comprising:
one or more processors; one or more memories; and one or more computer executable instructions embedded on the one or more memories, wherein the computer executable instructions are configured to execute:
a unified encoder comprising a neural network encoding data into one or more feature vectors, wherein the unified encoder is trained using machine learning to generate the one or more feature vectors useful for performing a plurality of different tasks each comprising different interpretations of the data; and
a plurality of decoders connected to the unified encoder, each of the decoders comprising a neural network interpreting the one or more feature vectors so as to decode one or more of the feature vectors to output one of the interpretations.

2. The computer implemented system of claim 1, wherein the different interpretations comprise at least one of a different classification or a conversion of the data into a different data format.

3. The system of claim 1, wherein the data comprises first image data, and the different interpretations comprise at least one of text data, second image data, or semantic segmentation.

4. The system of claim 1, wherein the different tasks comprise image captioning or natural language processing, semantic segmentation, and image reconstruction.

5. The system of claim 1, wherein the unified encoder is trained using mutual transfer learning and the different tasks comprise commonalities or utilize shared information, e.g., text.

6. The system of claim 1, wherein the unified encoder is trained using the machine learning comprising a first model for performing a first one of the different tasks and a second model for performing a second one of the different tasks, and a training of the unified encoder alternates between the first model and the second model after an epoch or trains both methods each epoch.

7. The system of claim 1, wherein:
the system comprises a distributed network of the processors,
the unified encoder is modular so that the unified encoder can be transmitted between different ones of the processors and executed or trained on each of the different ones of the processors, and
the decoders can be executed on different ones of the processors.

8. The system of claim 1, wherein:
the data comprises an image;
the unified encoder executes a plurality of encoder convolution layers so as to output a first one of the feature vectors comprising an intermediate feature vector after a first plurality of the convolution layers and a final feature vector after all the convolution layers; and
one of the decoders comprises a semantic segmentation decoder executing a decoder convolution layer and deconvolution layers, the semantic segmentation decoder:
receives the intermediate feature vector and passing the intermediate feature vector through the decoder convolution layer to form a first output;
receives the final feature vector and passing the final feature vector through one a first one of the deconvolution layers to form a second output;
concatenates the first output and the second output to form a combined output; and
passes the combined output through at least a second one of the deconvolution layers to form the one of the interpretations.

9. The system of claim 8, wherein another one of the decoders comprises a natural language processing decoder:
receives only the final feature vector;
flattens the final feature vector to form a flattened feature vector;
passes the flattened feature vector through a fully connected layer to reduce a number of dimensions and form a reduced dimension feature vector;
concatenates the reduced dimension feature vector with a previous hidden state and previous hidden word, if necessary; to form a concatenated layer;
inputs the concatenated layer to a bidirectional GRU layer to form a GRU output; and
passes the GRU output through at least one fully connected layer so as to reduce a dimensions and form another of the interpretations comprising a word output.

10. The system of claim 9, wherein another one of the decoders comprises an image reconstruction decoder:
successively deconvolutes the final feature vector through a plurality of deconvolution layers so as to reconstruct the data comprising an image.

11. The system of claim 10, wherein hidden layers in the image reconstruction decoder and the semantic segmentation decoder are equipped with RELU activation.

12. The system of claim 8, wherein the unified encoder comprises a spatial pyramid pooling layer after the convolution layers.

13. The system of claim 1, wherein the different tasks comprise terrain classification and image captioning.

14. The system of claim 1, wherein the unified encoder comprises a RES NET neural network, an Xception neural network, or a MobileNet neural network.

15. The system of claim 1, further comprising a machine coupled to or including one of the processors, wherein the machine comprises a vehicle, a spacecraft, a weapon, an aircraft, a robot, a medical device, an imaging device or camera, a rover, a sensor, an actuator, an intelligent agent, or a smart device in one or more smart buildings, wherein the machine utilizes one or more of the interpretations for operation of the machine.

16. The system of claim 1, further comprising an apparatus coupled to or including one of the processors and utilizing the interpretations for operation of the apparatus, wherein the apparatus comprises at least one machine selected from a machine performing automated manufacturing, devices controlled by a control system, one or more devices used in banking, one or more devices supplying power or controlling power distribution, or one or more devices in an automotive or aerospace system.

17. The system of claim 15, comprising a control system actuating motion of the machine in response to the interpretations.

18. The system of claim 1, further comprising a display displaying the interpretations and a camera for capturing the data.

19. A method for interpreting data using machine learning, comprising:
training a unified encoder, comprising neural network, using one or more machine learning models, to generate one or more training feature vectors useful for performing a plurality of different tasks each comprising different interpretations of training data;
encoding new data, using the unified encoder, into one or more feature vectors, to generate the one or more feature vectors useful for performing the plurality of different tasks each comprising the different ones of the interpretations of the new data; and
interpreting the one or more feature vectors, using a plurality of decoders connected to the unified encoder, each of the decoders comprising a neural network outputting a different one of the interpretations of the new data.

20. The method of claim 19, wherein the training comprises mutual transfer learning comprising propagating a gradient across orthogonal task specific parameter spaces.
